(19) United States
(12) Patent Application Publication
(10) Pub. No.: US 2025/0336012 A1
(43) Pub. Date: Oct. 30, 2025

(54) AIRCRAFT RE-FUELING MANAGEMENT METHOD AND SYSTEM WITH GPS AND OPERATIONAL VERIFICATION

(71) Applicants: Wade D. CONLEY, Grapevine, TX (US); David A. CONLEY, Desoto, TX (US); Steven P. PERRIN, Irving, TX (US)

(72) Inventors: Wade D. CONLEY, Grapevine, TX (US); David A. CONLEY, Desoto, TX (US); Steven P. PERRIN, Irving, TX (US)

(21) Appl. No.: 18/651,465

(22) Filed: Apr. 30, 2024

(51) Int. Cl. G06Q 50/06; G06V 30/142; H04W 4/029

(52) U.S. Cl. CPC G06Q 50/06; G06Q 10/20; G06V 30/142; H04W 4/029

(57) ABSTRACT

A control method and system for managing aircraft fueling operations operated by a fleet operator wherein the fleet operator has a central computer system and operates at multiple locations. The control method and system utilizes hand-held control terminals with GPS receivers and mobile refueling apparatuses with GPS receivers. The control method comprising the steps of: verifying that an aircraft is at the expected/proper gate by detecting an aircraft identification indicia and communicating the indicia to the central computer system; verifying that a refueling operator is certified to fuel the aircraft; verifying that the hand-held control terminal is at the proper gate by comparing its GPS location with an expected GPS location for the hand-held control terminal; and verifying that the refueling apparatus is at the proper gate by comparing its GPS location with an expected GPS location for the refueling apparatus.

### TECHNICAL FIELD

The present invention relates to an aircraft re-fueling management system for aviation fleets.

### BACKGROUND OF THE INVENTION

In the past, it has been known to attempt fuel management at airports using a more or less decentralized approach. An example of such is shown in U.S. Pat. No. 7,376,495, which shows and describes a system that collects data with a hand-held computer (the so-called fueling agent client device) and forwards it to a local server (the “fuel management server” 102).

As shown in FIG. 1 of the U.S. Pat. No. 7,376,495 patent and as described in its specification, the system taught by the patent is a client-server arrangement in which the server 102 collects information from an external airline computer system, collects data from the client device, and makes management fueling decisions as required by the fueling agent client device (the master device).

The U.S. Pat. No. 7,376,495 patent further describes that the local server's database is a local “master” database and is regularly synchronized with the airline's database. Because the airline's data can change frequently and quickly, the synchronization is carried out very frequently (on the order of every few seconds or so).

Thus, according to the U.S. Pat. No. 7,376,495 patent, the system disclosed therein uses a local server at the airport and the local server creates and maintains its own database of information for that airport. The local server does the computing and sends the fueling confirmation message to an ACARS radio relay system to relay it on to the pilot in the cockpit. Periodically (very frequently, actually), the local database has to be synchronized with the airline computer system. Indeed, the '495 Patent states “The fuel management server 102 stores its own copy of the fuel planning information and flight information (e.g., in database 118). The fuel management server 102 periodically synchronizes its local copy of the fuel planning information and flight information with updated information from the airline computer system”.

An unfortunate side effect of using a local server in this way is that it requires a separate server for each airport. If the airlines were operating at just one or two airports, such might be practical. But it becomes problematic if a large number of airports are involved. In practice there can be hundreds of airports for a given fleet operator (like an airline), leading to substantial complexity and difficulties.

This local server arrangement leads to significant unreliability. As the number of airports being serviced by such a system grows for a single airline operating such a system, the number of synchronizations going on begins to become unwieldy, leading to frequent downtime as data discrepancies between the databases and/or communication conflicts bring one or more systems off-line. For example, at the time of filing this patent application, at least one airline operates at hundreds of airports and utilizes a Varec, Inc. system in keeping with the U.S. Pat. No. 7,376,495 patent. To use the patented system for such an airline means that there are hundreds of servers connected to the airline computer system, with each server attempting to synchronize its local database on a more or less steady basis. Such an implementation can lead to a substantial reliability issue for the airline.

U.S. Pat. No. 8,666,586 addresses the above problems and discloses an enterprise fuel management system for managing fueling operations of an aircraft fleet operated by a fleet operator having a central computer system at a data center and operating aircraft at multiple airports to avoid reliability problems associated with synchronizing a central database with local databases. Data collection units communicate collected fueling information wirelessly to a central data center, and the data collection units are not in direct communication with the fleet operator's central computer system. Moreover, the central data center gathers fueling information from the various data collection units and communicates the gathered fueling information to the fleet operator's central computer system as data messages for subsequent processing and action. In this way, the fleet operator's central computer system can maintain the only database of fueling information and flight information, obviating the (prior art's) need to synchronize the data in the fleet operator's computer system with data in some other computer system.

Moreover, there exists a need for a fuel management system that is highly reliable, that ensures that the fuel delivery equipment is operating correctly, that the operator thereof is an authorized operator, and that the correct aircraft is being refueled. It is to the provision of such that the present invention is primarily directed.

### SUMMARY OF THE INVENTION

Briefly described, in a first example embodiment the present invention relates to a control method and system for managing aircraft fueling operations operated by a fleet operator. In the control method and system, preferably the fleet operator has a central computer system and operates at multiple locations. The control method and system preferably utilizes hand-held control terminals with GPS receivers and mobile refueling apparatuses with GPS receivers. Preferably, the control method comprising the steps of:
verifying that an aircraft is at the expected/proper gate by detecting an aircraft identification indicia and communicating the indicia to the central computer system;
verifying that a refueling operator is certified to fuel the aircraft by requiring the refueling operator to securely log in to a hand-held control terminal;
verifying that the hand-held control terminal is at the proper gate by comparing its GPS location with an expected GPS location for the hand-held control terminal; and
verifying that the refueling apparatus is at the proper gate by comparing its GPS location with an expected GPS location for the refueling apparatus.

Optionally, the step of detecting an aircraft identification indicia can be carried out by human observation and notation of the aircraft ship number. Optionally, the step of detecting an aircraft identification indicia can be carried out by human observation and notation of the aircraft registration number.

Optionally, the step of detecting an aircraft identification indicia can be carried out by OCR observation and notation of the aircraft ship number using the hand-held control unit. Also optionally, the step of detecting an aircraft identification indicia can be carried out by OCR observation and notation of the aircraft registration number using the hand-held control unit.

Optionally, the method can include the additional step of verifying that the fueling equipment is in working order. Preferably, the step of verifying that the fueling equipment is in working order is carried out by performing one or more diagnostic checks of the fueling equipment. Optionally, the fueling equipment is in cellular communication with the central computer system and wherein the status of the working order of the fueling equipment is communicated to the central computer system periodically. Optionally, temperature and humidity inside a portion of the fueling equipment is monitored and communicated to the central computer system periodically. Also optionally, a battery portion of the fueling equipment is monitored for voltage and the battery voltage is communicated to the central computer system periodically.

Optionally, the present invention utilizes hand-held devices at each location and which forward their collected data to a data center in a central location. The central data center then forwards the aggregated data to the fleet operator's data center as data messages (for example, as MQ messages). The fleet operator's computer systems then use the data, take action in response to the data, forward messages to the pilot through the ACARS system utilizing the data, etc. In this regard, the central data center is more like a data forwarding station, sorting out the various incoming raw data received from the various hand-held units and managing the communication to the airline data center (acting like a traffic cop, of sorts). Importantly, in this arrangement, there is only one database (the fleet operator's), so there is no synchronization needed.

Optionally, the present invention can be implemented in an enterprise fuel management system for managing fueling operations of an aircraft fleet operated by a fleet operator having a central computer system at a data center and operating aircraft at multiple airports. The system includes a central data center in communication with the fleet operator's central computer system for forwarding data to the fleet operator's central computer system. The system also includes, at each airport, one or more data collection units for collecting fueling information and forwarding it to the central data center. Advantageously, the data collection units communicate the collected fueling information wirelessly to the central data center, and the data collection units are not in direct communication with the fleet operator's central computer system. Moreover, the central data center gathers fueling information from the various data collection units and communicates the gathered fueling information to the fleet operator's central computer system as data messages for subsequent processing and action.

Optionally, the data collection units are hand-held computer devices that communicate wirelessly with the central data center via cellular communication.

Optionally, the data collection units can communicate wirelessly by cellular, WiFi, or satellite. Also, the data collection units can comprise in-cab computer devices or fuel data units mounted on trucks or stationary carts.

These example embodiments of the present invention, and further example embodiments of the invention, will be understood further from the following detailed description and the appended drawings.

### BRIEF DESCRIPTION OF THE DRAWING FIGURES

FIG. 1 is a schematic flowchart of a method of refueling aircraft according to an example form of the present invention.

FIG. 2 is a schematic flowchart of a method of refueling aircraft according to another example form of the present invention.

FIG. 3 is a schematic illustration of an example hand-held device for use with the methods of FIGS. 1 and 2.

FIG. 4 is a schematic illustration of an example system for use with the methods of FIGS. 1 and 2.

FIG. 5 is a schematic illustration of an airport, with several gates, aircraft at the several gates, and equipment in use with the methods of FIGS. 1 and 2.

### DETAILED DESCRIPTION

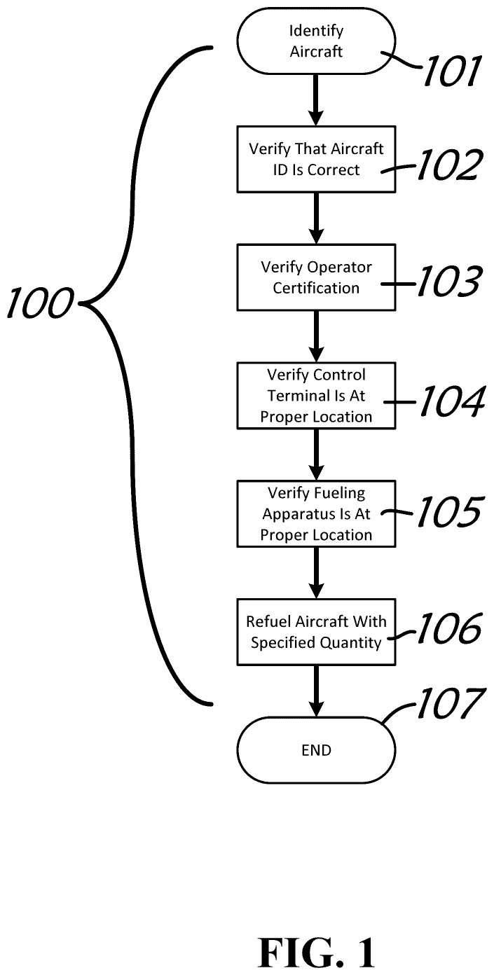

Turning now to the drawing figures, wherein like reference numerals represent like parts throughout the several views, FIGS. 1 et seq. show an enterprise fuel management control method and system 100. The enterprise fuel management system and method 100 is adapted for managing fueling operations of an aircraft fleet operated by a fleet operator having a central computer system at a data center for operating aircraft at multiple airports.

In a first example embodiment the present invention relates to a control method and system 100 for managing aircraft fueling operations operated by a fleet operator. In the control method and system, the fleet operator has a central computer system and operates at multiple locations. The control method and system utilizes hand-held control terminals with GPS receivers and mobile refueling apparatuses with GPS receivers.

Preferably, the control method comprises a number of steps, including Step 101 in which the aircraft is identified. This can be carried out in a number of way, including manually observing and recording the aircraft indicia, using a device to read the aircraft indicia from the exterior of the aircraft (such as using OCR to read the ship number or the aircraft registration number. Alternatively, a bar code or QR code can be read from the exterior of the aircraft and the code read with equipment and stored.

In Step 102, the method includes verifying that the aircraft is at the expected/proper gate by communicating the identifying aircraft indicia to the central computer system, where it is checked against data showing which aircraft is expected to be at the gate at that particular moment.

In Step 103, the method includes verifying that a refueling operator is certified to fuel the aircraft by requiring the refueling operator to securely log in to a hand-held control terminal. If the refueling operator is unable to log in, then by default he/she is not a certified operator. If he/she manages to log in, the log in credentials are checked to verify that this operator is certified or approved to be refueling aircraft using the refueling equipment.

In Step 104, the method includes verifying that the hand-held control terminal is at the proper gate. This is accomplished by comparing the GPS location of the hand-held control terminal with an expected GPS location for the hand-held control terminal to ensure that it is at the proper gate.

In Step 105, the method includes verifying that the refueling apparatus is at the proper gate by comparing its GPS location with an expected GPS location for the refueling apparatus.

In Step 106, the method includes refueling the aircraft using the refueling apparatus, after which the method ends at Step 107.

Optionally, Step 101 of detecting an aircraft identification indicia can be carried out by human observation and notation of the aircraft ship number. Optionally, Step 101 of detecting an aircraft identification indicia can be carried out by human observation and notation of the aircraft registration number. Optionally, Step 101 of detecting an aircraft identification indicia can be carried out by OCR observation and notation of the aircraft ship number using the hand-held control unit. Also optionally, Step 101 of detecting an aircraft identification indicia can be carried out by OCR observation and notation of the aircraft registration number using the hand-held control unit.

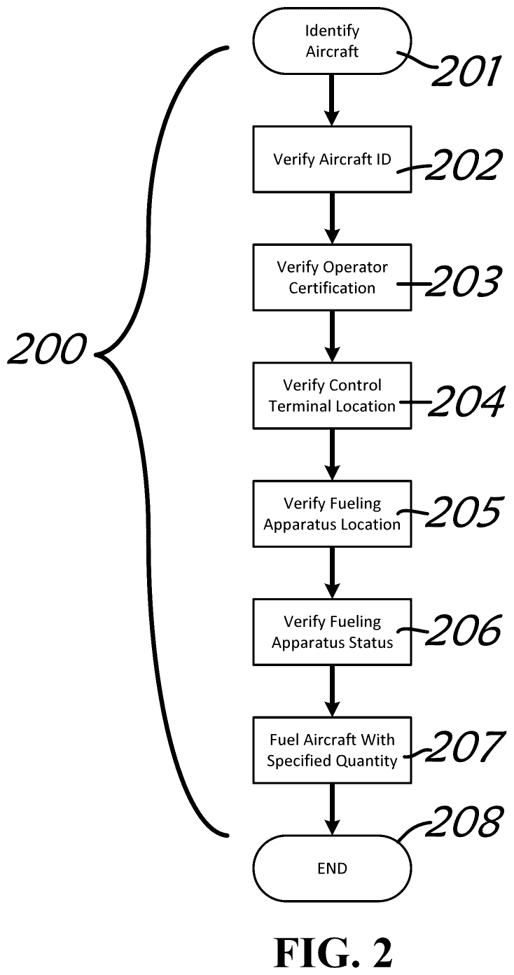

Optionally, as shown in FIG. 2, a method 200 can include the additional step of verifying that the fueling equipment is in working order. Preferably, the control method 200 comprises a number of steps, including Step 201 in which the aircraft is identified. In Step 202, the method includes verifying that the aircraft is at the expected/proper gate by communicating the identifying aircraft indicia to the central computer system, where it is checked against data showing which aircraft is expected to be at the gate at that particular moment. In Step 203, the method includes verifying that a refueling operator is certified to fuel the aircraft by requiring the refueling operator to securely log in to a hand-held control terminal. In Step 204, the method includes verifying that the hand-held control terminal is at the proper gate. This is accomplished by comparing the GPS location of the hand-held control terminal with an expected GPS location for the hand-held control terminal to ensure that it is at the proper gate. In Step 205, the method includes verifying that the refueling apparatus is at the proper gate by comparing its GPS location with an expected GPS location for the refueling apparatus. In Step 206, the method includes verifying that the fueling equipment is in working order. In Step 207, the method includes refueling the aircraft using the refueling apparatus, after which the method ends at Step 208.

Preferably, Step 206 of verifying that the fueling equipment is in working order is carried out by performing one or more diagnostic checks of the fueling equipment. Optionally, the fueling equipment is in cellular communication with the central computer system and wherein the status of the working order of the fueling equipment is communicated to the central computer system periodically. Optionally, temperature and humidity inside a portion of the fueling equipment is monitored and communicated to the central computer system periodically. Also optionally, a battery portion of the fueling equipment is monitored for voltage and the battery voltage is communicated to the central computer system periodically.

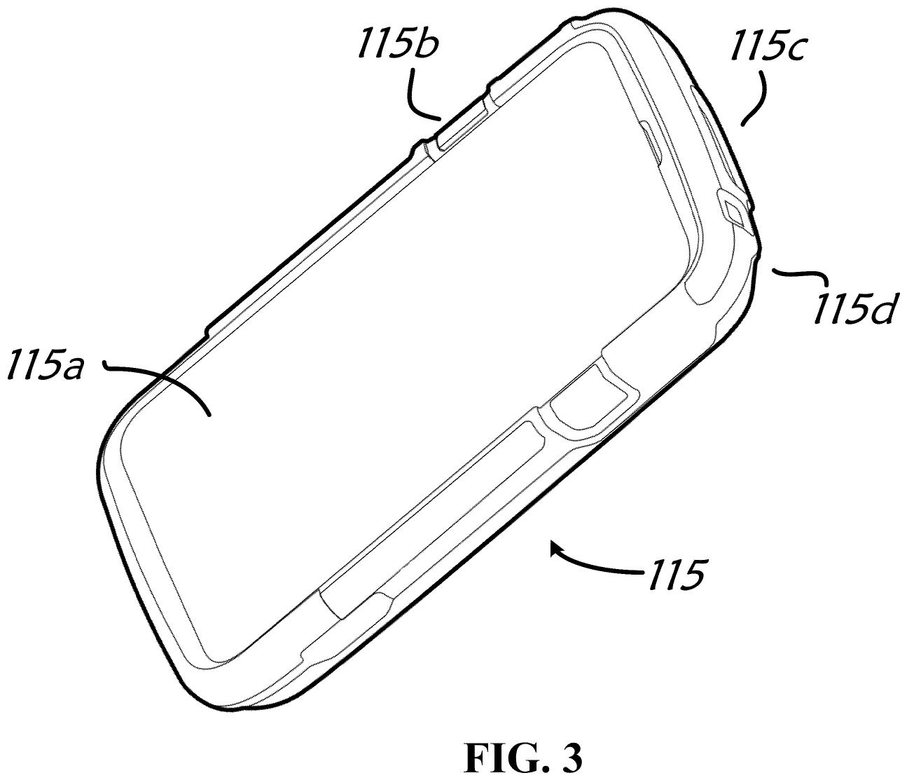

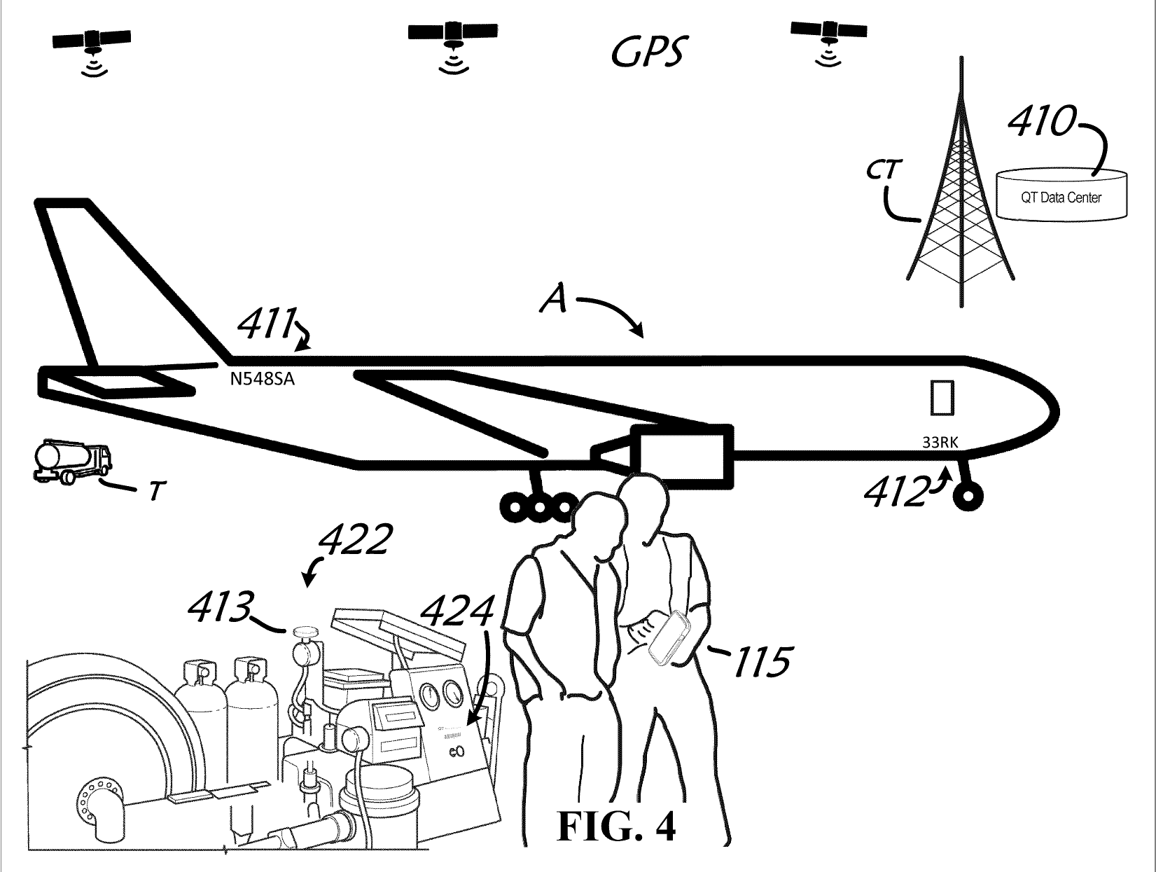

As shown in FIG. 3, a representative example of a hand-held terminal 115 that a fueler could use to communicate and control the loading of fuel onto an aircraft. The terminal 115 preferably has multiple Radio Frequency interfaces: Cellular, GPS, WiFi, Bluetooth as well as multiple Optical inputs: Bar Code scanner 115c, Front and Rear high resolution color cameras 115d. The screen display 115a provides information from the enterprise fuel management system and the touch screen allows input of control and data information. Buttons 115b initiate a bar code scanning operation. That bar code 424 can be used to confirm that the correct equipment 422 is present (see FIG. 4). The fueler can also capture images with the cameras by pressing either a side button 115b or an icon on the display 115a.

One preferred version of such a hand-held terminal 115 is the Honeywell CT60, a pocket-sized hand-held computer device, which allows one to use its built-in bar code reading capability to capture fueling equipment identity information 124 quickly, reliably, and easily. The software application running on hand-held devices (or in-cab computing devices) that captures the fuel quantities can be updated remotely over the wireless network. In addition, client support personnel can remotely log in to the hand-held device (or in-cab computing device) to help the fuelers with any problems as well as monitor the devices for battery life and wireless networks signal strength. The hand-held device 115 (or in-cab computing device) user must log in to the device, protecting airline and business partner data and with integration to the staff management system, can ensure that the fueler has been trained to use the system and is certified to execute the fuel order for the type of aircraft assigned to the flight.

The overall fueling operation at a gate is shown in the diagram of FIG. 4. Preferably, the hand-held devices (115) are linked to the Enterprise data center 410 by cellular communication links. In this regard, the hand-held devices are linked wirelessly to a cell tower CT and then on to the message data center 410 through the cellular network and other means. Alternatively, the hand-held devices can communicate to a local WiFi network and then on to the message data center 410. Typically, the airline computer system includes an airline flight information system and an airline fueling data system (in some installations these are combined into a single system).

The aircraft A parked at the gate has two methods of being externally identified: The government issued tail number 411, and the airline industry's 412 ship number ID. One or both are entered on the hand-held 115 either manually or by camera capture and optical character recognition.

The system can be configured to allow a refueling team to enter flight dispatch information and can use real-time GPS (global positioning system) tracking of the in-cab computing device in the fueling truck. Alternatively, the hand-held devices 115 can include a GPS receiver for real-time tracking of the position of the hand-held devices. Likewise, the data capture device on a fuel truck T or stationary/towable hydrant cart 422 can be outfitted with a GPS receiver for tracking of the truck T or stationary/towable hydrant cart 422. The fueling trucks can be tanker trucks or so-called hydrant trucks. The fuel truck T and/or the stationary/towable hydrant cart 422 preferably can be outfitted with a Fuel Data Unit (FDU) 413 for capturing fueling data as fuel is dispensed.

Fueling equipment is identified by permanently affixed bar-code labeling that is scanned by the hand-held terminal or the printed number entered manually.

The data captured within the Fuel Data Unit 413 is transmitted to the handheld device without missing any information, is passed to the data center and then on to the airline's data systems. The FDU can also communicate directly through a redundant path using a cellular connection. That cellular link is also how GPS coordinates are sent to the enterprise to verify the equipment is at the correct gate. The FDU 413 can be outfitted and configured to capture various operating parameters of the FDU, such as ambient temperature, operating temperature of the fueling apparatus or the fuel, humidity, battery voltage, etc. In the case of battery voltage, this can be especially helpful since in some instances the equipment is battery-powered and the battery(ies) is(are) charged by solar panels. Thus, maintaining proper operating voltages can be important. These data can be captured and forwarded to the enterprise for consideration and evaluation of the operation of the fueling equipment and to adjust for such operating conditions.

The system is configured to check the fueler's certification status to ensure he/she is qualified to fuel the type of plane used for the flight. To accomplish this, the airline's database can be queried to verify that the person doing the fueling is properly qualified for that model of aircraft to be fueled.

Optionally, the system can be configured to check the the fueler's certification status to be sure he is qualified to the fuel the type of plane used for the flight. To accomplish this, the airline's database can be queried to verify that the person doing the fueling is properly qualified for the particular aircraft to be fueled.

Also optionally, the system can be configured to use satellite communications where no Wi-Fi or cellular service is available. In certain situations there may not be a reliable communication system of any kind, and in such situations the system can provide a batch processing data upload/download capability.

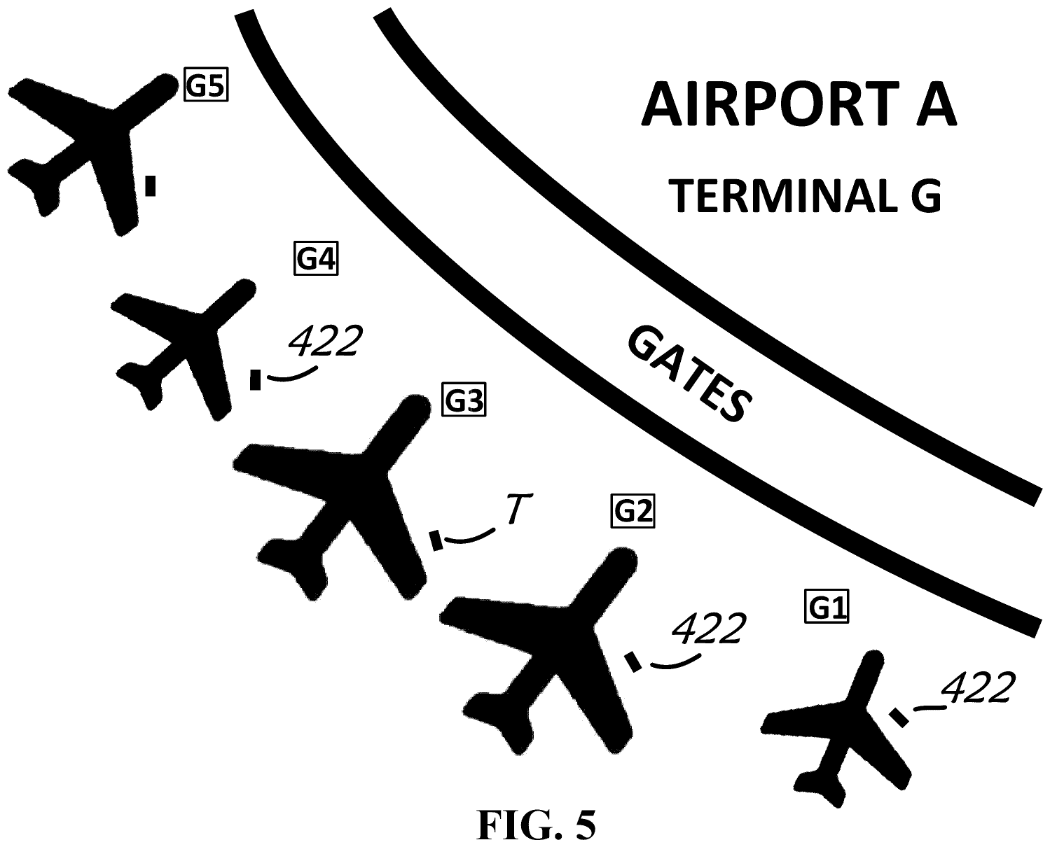

FIG. 5 depicts, schematically, a typical airport with a terminal and five (5) gates at the terminal. Each gate (G1-G5) depicted in FIG. 5 has an aircraft parked at the gate. Each of the depicted aircraft parked at the gates is being serviced (refueled) by a truck T or a cart/towable hydrant 422.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A control method for managing aircraft fueling operations operated by a fleet operator having a central computer system and operating at multiple locations and utilizing hand-held control terminals with GPS receivers and mobile refueling apparatuses with GPS receivers, the control method comprising the steps of:
verifying that an aircraft is at the expected/proper gate by detecting an aircraft identification indicia and communicating the indicia to the central computer system;
verifying that a refueling operator is certified to fuel the aircraft by requiring the refueling operator to securely log in to a hand-held control terminal;
verifying that the hand-held control terminal is at the proper gate by comparing its GPS location with an expected GPS location for the hand-held control terminal; and
verifying that the refueling apparatus is at the proper gate by comparing its GPS location with an expected GPS location for the refueling apparatus.

2. A control method as claimed in claim 1 wherein the step of detecting an aircraft identification indicia is carried out by human observation and notation of the aircraft ship number.

3. A control method as claimed in claim 1 wherein the step of detecting an aircraft identification indicia is carried out by human observation and notation of the aircraft registration number.

4. A control method as claimed in claim 1 wherein the step of detecting an aircraft identification indicia is carried out by OCR observation and notation of the aircraft ship number using the hand-held control unit.

5. A control method as claimed in claim 1 wherein the step of detecting an aircraft identification indicia is carried out by OCR observation and notation of the aircraft registration number using the hand-held control unit.

6. A control method as claimed in claim 1 further comprising the step of verifying that the fueling equipment is in working order.

7. A control method as claimed in claim 6 wherein the step of verifying that the fueling equipment is in working order is carried out by performing one or more diagnostic checks of the fueling equipment.

8. A control method as claimed in claim 6 wherein the fueling equipment is in cellular communication with the central computer system and wherein the status of the working order of the fueling equipment is communicated to the central computer system periodically.

9. A control method as claimed in claim 8 wherein temperature and humidity inside a portion of the fueling equipment is monitored and communicated to the central computer system periodically.

10. A control method as claimed in claim 8 wherein a battery portion of the fueling equipment is monitored for voltage and the battery voltage is communicated to the central computer system periodically.
